(19) United States
(12) Patent Application Publication
(10) Pub. No.: US 2004/0222597 A1
(43) Pub. Date: Nov. 11, 2004

(54) Gasket for a pipe

(76) Inventor: Arnold George Benecke, Wharton, OH (US)

Correspondence Address: Lorri W. Cooper, Jones Day, North Point, 901 Lakeside Avenue, Cleveland, OH, 44114, US

(21) Appl. No.: 10/434,651

(22) Filed: May 9, 2003

(51) Int. Cl. H02G 15/013

(52) U.S. Cl. 277/602

(57) ABSTRACT

A gasket for use with a pipe includes an annular member having a plurality of legs coupled to a vertical member. One of the legs is an annular projection that extends outwardly from the annular member. The vertical member and some of the legs form a base portion, with the annular projection extending outwardly from the base portion. The base portion may have an I-shaped cross section. Alternatively, the annular member may have a cross-shaped cross section. The gasket is sized to seat in a groove of a pipe. A pipe joint and corrugated pipe are also provided that utilize the gasket. A method of sealing a pipe joint and a method of manufacturing a gasket are also described.

### FIELD OF THE INVENTION

The claimed invention relates to a gasket for a pipe. In particular, the invention concerns a gasket for use with a pipe for producing a soil tight seal between adjoining pipes.

### BACKGROUND OF THE INVENTION

Pipe assemblies are generally made of plastic, polyethylene, metal, concrete, or other suitable materials. Pipes are fabricated in many configurations and sizes to meet specific requirements. Many of these pipe assemblies utilize corrugated pipe structures, where a plurality of alternating ridges and valleys are provided along the lengths of the pipes in the assembly. Corrugated pipes generally include a spigot end and a bell end. The bell end generally has a larger diameter than the spigot end and is sized and configured to extend around the spigot end so that like pipes may be adjoined by inserting the spigot end of one pipe into the bell end of another pipe.

Gaskets have been used to form seals between the bell and spigot for various purposes. AASHTO is a requirement setting agency that represents transportation and highway departments in the 50 states, the District of Columbia, and Puerto Rico. AASHTO specifications are intended to protect the public from use of loose fitting or porous joints between pipe sections that can allow soil fines to infiltrate the pipe at the joint and cause dangerous excavation or erosion of soil around the pipeline. One type of seal covered by AASHTO specifications is a water tight seal, which is a seal that prevents the ingress or egress of water across the seal. Another type of seal is a silt tight seal, which prevents the ingress or egress of silt across the seal. Water tight and silt tight seals are pressure rated, so that they are required to seal under a given pressure range.

AASHTO recently introduced a new category of pipe joint under AASHTO M294-02, which provides for a soil tight seal. This soil tight seal is not pressure rated and requires that the joint have a gap between the bell and spigot not greater than 3 mm and the gap length (annular space between the bell and spigot) must be a length four times the gap.

### SUMMARY

According to one embodiment of the invention, a gasket for use with a pipe includes an annular member having a plurality of legs coupled to at least one vertical member. At least one of the plurality of legs is an annular projection that extends at least partially radially outwardly from the annular member.

The at least one vertical member and at least some of the plurality of legs may form an annular base portion. The at least one annular projection extends outwardly from the base portion. The annular base portion may have an I-shaped cross-section, with the annular base portion and the at least one annular projection being made of a pliable material.

The annular member may alternatively have a cross-shaped cross-section, with the at least one vertical member being coupled to the annular projection to form an upright beam of the cross-shape. The plurality of legs may comprise at least one horizontal member extending outwardly from the sides of the vertical member and the annular projection in the vicinity of where the vertical member and annular projection are coupled. The at least one horizontal member forms a cross-beam of the cross-shaped cross section. At least a portion of the annular member is configured to seat within an annular groove defined in a pipe and at least a portion of the annular member is configured to extend from the annular groove of the pipe.

In yet another embodiment of the gasket, a gasket for use with a pipe includes an annular member formed of a pliable material. The annular member has a first portion sized for seating in an annular groove defined in a pipe and a second portion extending outwardly from the first portion. The second portion is for engaging an inner wall of an adjoining pipe. The pliable material consists essentially of a polyolefin polymer.

In another embodiment of the invention, a pipe joint includes a first pipe section, a second pipe section, and one of the gaskets described above. The gasket sealingly engages the first pipe section and the second pipe section in a manner to prevent the leakage of soil between the two pipe sections.

In yet another embodiment, a corrugated pipe includes an elongated tubular member and one of the gaskets, described above. The tubular member has a bell end and a spigot end, with at least one annular groove being provided on one of the spigot end and the bell end. The annular gasket is configured to seat in the at least one annular groove, with at least part of the gasket extending outwardly from the groove.

In a further embodiment, a method of sealing a pipe joint includes providing one of the gaskets, described above. The method also includes providing an annular groove in a pipe that is sized to seat at least a portion of the annular member, and installing the gasket in the annular groove of the pipe.

In another embodiment, a method of manufacturing a gasket for use with a pipe includes providing a mold configured to form one of the gaskets, described above, as a unitary member, and injection molding a polyolefin polymer into the mold.

### BRIEF DESCRIPTION OF THE DRAWING FIGURES

FIG. 1 is a perspective view of two mating sections of pipe, with a gasket according to the invention being installed on the end portion of one of the pipes;

FIG. 2 is a side view of a gasket according to the invention;

FIG. 3 is a top view of the gasket of FIG. 2;

FIG. 4 is a cross-sectional view of the gasket of FIG. 2, taken at line 4-4 in FIG. 2;

FIG. 5 is an expanded cross-sectional view of the gasket of FIG. 2 installed in an annular groove of a pipe;

FIG. 6 is a side view of another embodiment of a gasket according to the invention;

FIG. 7 is a top view of the gasket of FIG. 6;

FIG. 8 is a cross-sectional view of the gasket of FIG. 6, taken at line 8-8 in FIG. 6;

FIG. 9 is an expanded cross-sectional view of the gasket of FIG. 6 installed in an annular groove of a pipe;

FIG. 10 is a partial cross-sectional view of two mating sections of pipe showing the gasket of FIG. 2 installed in an annular groove of the spigot portion of one of the pipe sections;

FIG. 11 is a partial cross-sectional view of two mating sections of pipe showing the gasket of FIG. 6 installed in an annular groove of the spigot portion of one of the pipe sections; and

FIG. 12 is a partial cross-sectional view of two mating sections of pipe showing the gasket of FIG. 2 installed in a corrugation valley of the spigot portion of one of the pipe sections.

### DETAILED DESCRIPTION OF THE INVENTION

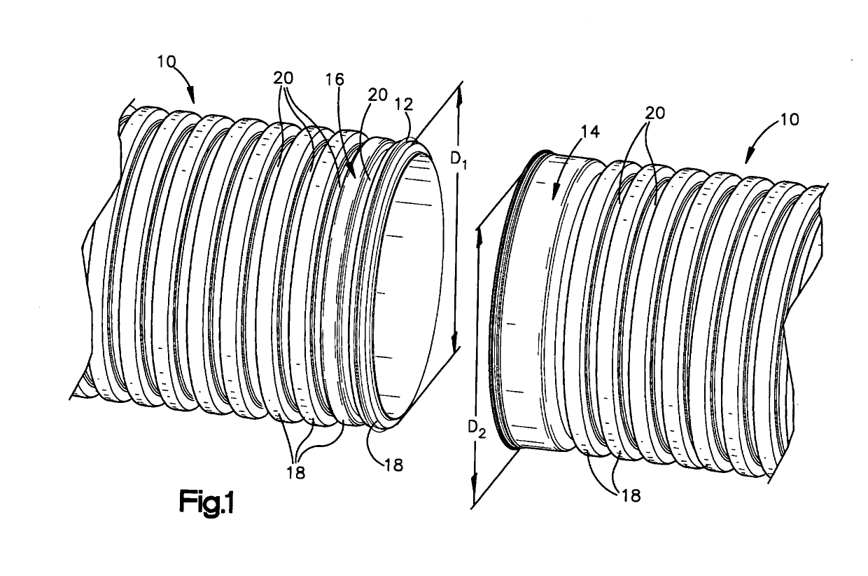

The invention concerns a pipe 10 having a gasket 12 installed for sealing purposes. In a preferred embodiment, shown in FIG. 1, the pipe 10 is a corrugated pipe having a bell 14 at one end and a spigot 16 at the other end. The majority of the length of the pipe 10 has a corrugation structure, which includes a plurality of alternating ridges 18 and valleys 20, as known by those of skill in the art. The spigot 16 of the pipe 10 has a smaller diameter D1 than the diameter D2 of the bell 14 of the pipe 10. When similar pipes 10 are utilized, the spigot 16 of a first pipe is insertable into the bell 14 of a second pipe in order to join the pipes into a pipe assembly and form a pipe joint 22. It is preferred that the spigot 16 be only slightly smaller dimensionally than the bell 14 such that the bell 14 and spigot 16 are in relatively close proximity to one another when installed together.

The dimensions of the bell 14 and spigot 16, when combined with a sealing member, such as the gasket 12 of the present invention, provide a sealing function. In the present invention, the sealing function that is provided by the gasket 12 is a soil tight seal according to AASHTO requirement M294-02 (section 7.9.1). The gasket 12 is preferably a molded ring with a radially standing rib of a diameter D3 greater than the diameter D1 of the spigot 16.

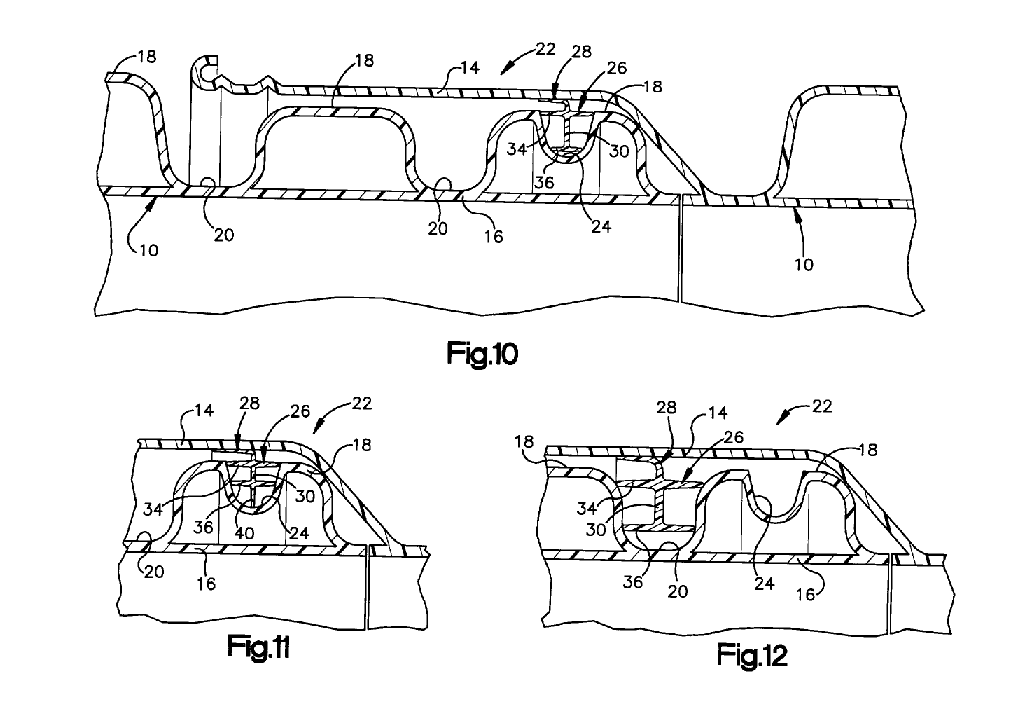

A bell 14 of a pipe 10 typically has a smooth walled structure into which the spigot 16 is inserted, and the spigot 16 typically includes corrugations. The corrugations include alternating ridges 18 and valleys 20. An annular groove 24 may be defined in one of the ridges 18 of the corrugation structure on the spigot 16. As shown in FIGS. 1 and 10-12, a preferred location for the annular groove 24 is in the first ridge 18 of the corrugation structure, although the annular groove 24 may be provided at other locations on the spigot 16. It is preferred that the gasket 12 be positioned so that it engages the bell 14 of an adjoining pipe 10 when the spigot 16 is fully inserted into the bell 14. In an alternative embodiment, more than one annular groove 24 may be provided on the spigot 16, such as a groove 24 in more than one of the ridges 18 of the corrugation structure (shown in FIG. 12). In yet another embodiment, the gasket 12 can be installed in one of the valleys 20 of the corrugation structure (not shown). In this embodiment, the gasket 12 will be larger dimensionally than if it were installed in the annular groove 24 in order to properly seat within the valley 20 and extend to meet the wall of the bell 14.

In yet another embodiment, more than one gasket 12 may be utilized, with each gasket 12 being positioned in an annular groove 24, or at least one of the gaskets 12 being positioned in the annular groove 24 and the other gasket(s) 12 positioned in a valley 20. Therefore, while the following discusses the seating of the gasket 12 within an annular groove 24, it should be noted that the gasket 12 may alternatively and interchangeably be seated in a corrugation valley 20, or in another groove, as long as the gasket 12 is properly sized for the groove and/or valley 20 utilized. Furthermore, while the following describes the gasket 12 as being seated in the spigot 16 of a pipe 10, the gasket 12 may alternatively be seated or positioned within an opening or groove (not shown) in the bell 14 of the pipe 10, the invention not being limited to placement of the gasket 12 on only the spigot 16 or only the bell 14. Thus, while the claims describe the gasket 12 as being configured to seat within an annular groove 24, the term “annular groove” or “groove” is meant to refer to an annular groove as defined in a corrugation ridge 18, a corrugation valley 20, or any other type of channel disposed on either the bell 14 or the spigot 16. The “annular groove” has a configuration that is conducive to receiving an annular gasket 12.

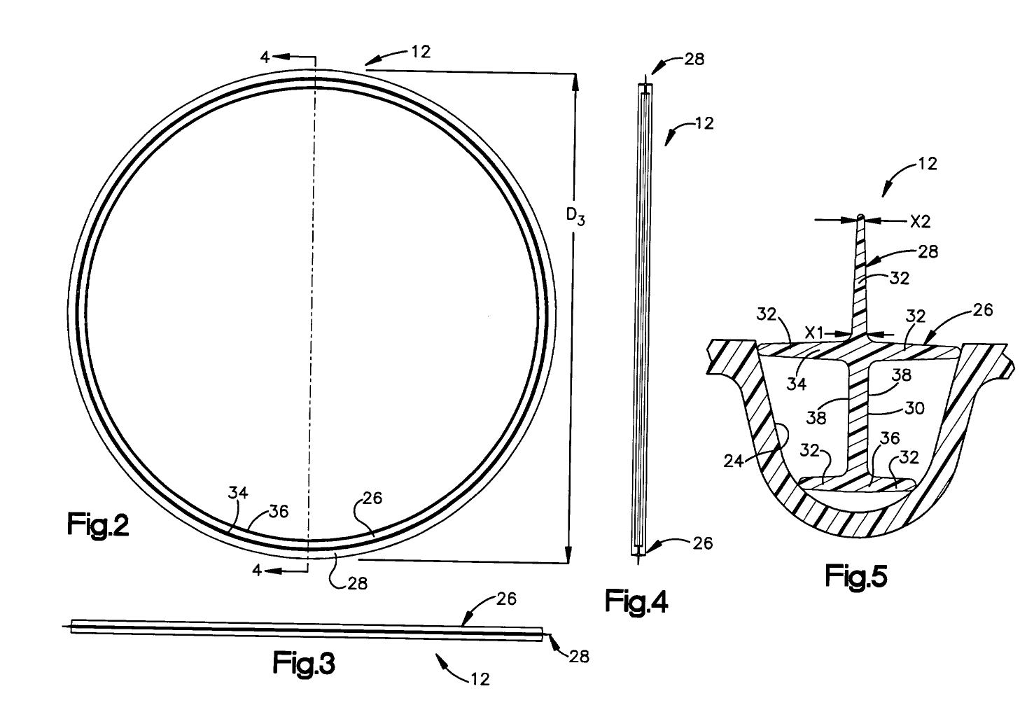

There is often some variation between corrugated pipes 10 that is caused by the pipe manufacturing process and/or the materials utilized to manufacture the pipes, among other reasons. As a result, some pipes 10 may be more oval than others and some pipes 10 may have greater dimensions than others of the same design. According to the AASHTO M294-02 requirements for a soil tight seal, a gasket 12 must provide a maximum gap between a bell 14 and a spigot 16 of 3 mm. The design of the present invention meets this requirement and preferably provides a zero gap between the bell 14 and spigot 16 of adjoining pipes 10, taking into account the maximum variation in size and ovality between pipes 10 of the same kind. It does so by providing a gasket 12 having a base portion 26 that is configured to seat in an annular groove 24 and a projection 28 that extends from the base portion 26 of the gasket 12, as shown in FIGS. 2-12.

FIGS. 2-5 show a first embodiment of the gasket 12 according to the invention. The gasket 12 is preferably annular and has a diameter D3 that allows for tight seating within an annular groove 24 defined in a pipe 10. As shown best in FIG. 5, the gasket 12 has an annular base portion 26 that includes a vertical member 30 and a plurality of legs 32 that extend from the vertical member 30. The plurality of legs 32 include an upper horizontal member 34 and a lower horizontal member 36, each of which extend from the sides 38 of the vertical member 30. The cross-sectional shape of the base portion 26 is I-shaped. The upper horizontal member 34 of the I-shaped base portion 26 is disposed at about a 90 degree angle to the vertical member 30 to form the upper beam of the I-shape. The lower horizontal member 36 of the I-shaped base portion 26 is disposed at about a 90 degree angle relative to the vertical member 30 to form the lower beam of the I-shape. Each of the horizontal members 34, 36 extend from the sides 38 of the vertical member 30 and are sized to engage the walls of the annular groove 24 of the pipe 10 in which the gasket 12 is seated. As shown in FIG. 5, the base portion 26 of the gasket 12 is completely seated within the annular groove 24.

The gasket 12 also includes as one of the plurality of legs 32 an annular projection 28 that extends outwardly from the base portion 26. The annular projection 28 also extends outwardly from the annular groove 24 of the pipe 10 when the gasket 12 is installed in the groove 24. In a preferred embodiment, the annular projection 28 is a linear rib that has a cross-sectional dimension that is smaller than a cross-sectional dimension of the vertical member 30. The projection 28 is designed to bend or crush when a sufficient force is applied to the projection 28, while maintaining a springing quality that allows the projection 28 to spring out against the surface of the opposing member when it is bent over.

In a preferred embodiment, the annular projection 28 is a linear rib that tapers from a first dimension X1 where it adjoins to the base portion 26 to a second dimension X2 at its tip. The first dimension X1 is greater than the second dimension X2. The projection 28 has a length that conforms to the size of the gap between the spigot 16 and bell 14 of adjoining pipes 10. As shown, the projection 28 also conforms to the inside shape of the opposing surface. The length allows the projection 28 to provide a zero gap between the bell 14 and spigot 16 when two like pipes 10 are joined. The projection 28 is preferably axially aligned with the vertical member 30. In an alternative embodiment (not shown), the projection 28 is not axially aligned with the vertical member 30 and may be angled relative to the vertical member 30 such that it extends only partially radially from the vertical member 30, or is displaced to one side of the vertical member 30 along the upper horizontal member 34.

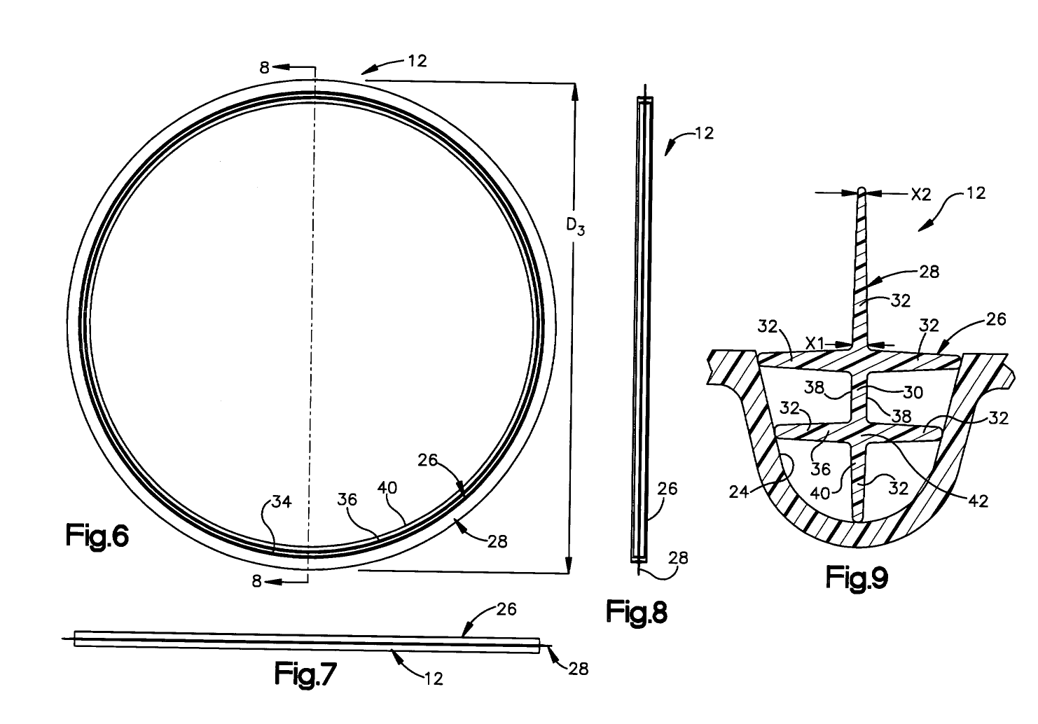

FIGS. 6-9 show an alternative embodiment of the gasket 12 according to the invention. The gasket 12 is preferably annular and sized to seat in an annular groove 24 defined in a pipe 10. As shown best in FIG. 9, the gasket 12 includes a base portion 26 and an annular projection 28 extending radially outwardly from the base portion 26. The base portion 26 includes a vertical member 30 and a plurality of legs 32 that extend from the vertical member 30. The plurality of legs 32 include an upper horizontal member 34, a lower horizontal member 36, and a lower vertical rib 40. The upper and lower horizontal members 34, 36 extend from the sides 38 of the vertical member 30 while the lower vertical rib 40 extends from the bottom 42 of the vertical member 30.

The cross-sectional shape of the base portion is I-shaped, but includes an extension at the bottom of the I-shape in the form of the vertical rib 40. The upper horizontal member 34 of the I-shaped base portion 26 is disposed at about a 90 degree angle to the vertical member 30 to form the upper beam of the I-shape. The lower horizontal member 36 of the I-shaped base portion 26 is disposed at about a 90 degree angle relative to the vertical member 30 to form the lower beam of the I-shape. Each of the horizontal members 34, 36 extend from the sides 38 of the vertical member 30 and are sized to engage the walls of the annular groove 24 of the pipe 10 in which the gasket 12 is seated. The vertical rib 40 adjoins with the base portion 26 to provide a lower leg that also engages the wall of the annular groove 24. The vertical rib 40 is an axial extension of the vertical member 30. The vertical rib 40 may include notches in the sides of the rib (not shown) to allow the rib 40 to bend more easily to provide a better fit within the annular groove 24. As shown in FIG. 9, the base portion 26 of the gasket 12 is preferably completely seated within the annular groove 24.

The gasket 12 also includes an annular projection 28 that extends outwardly from the base portion 26 and outwardly from the annular groove 24 of the pipe 10. In a preferred embodiment, the annular projection 28 is a linear rib that tapers from a first dimension X1 where it adjoins to the base portion 26 to a second dimension X2 at its tip. The first dimension X1 is preferably greater than the second dimension X2. The projection 28 is designed to bend or crush when a sufficient force is applied to the projection 28. The projection 28 has a length that conforms to the size of the gap between the spigot 16 and bell 14 of adjoining pipes 10. The length allows the projection 28 to provide a zero gap between the bell 14 and spigot 16 when two like pipes 10 are joined. The projection 28 is preferably axially aligned with the vertical member 30. In an alternative embodiment (not shown), the projection 28 is not axially aligned with the vertical member 30 and may be angled relative to the vertical member 30 or displaced to one side of the vertical member 30 along the upper horizontal member 34.

The gaskets 12 shown in FIGS. 2-9 may alternatively be considered as having a cross-shaped cross section that includes an annular projection 28, a vertical member 30, and at least one horizontal member. The embodiment shown in FIGS. 2-5 includes an upper horizontal member 34 that is coupled between the annular projection 28 and the vertical member 30, and a lower horizontal member 36 that is coupled to the bottom 42 of the vertical member 30. The embodiment shown in FIGS. 6-9 includes an upper horizontal member 34 that is coupled between the annular projection 28 and the vertical member 30, and a lower horizontal member 36 that is coupled to the bottom 42 of the vertical member 30. This embodiment also includes a lower rib 40 extending radially inwardly from the vertical member 30. The lower rib 40 is configured so that it engages the wall of the annular groove 24. The upper and lower horizontal members 34, 36 also engage the wall of the annular groove 24. The combination of the upper and lower horizontal members 34, 36 and the lower rib 40 are sized to conform to the wall of the annular groove 24 in order to provide a tight and secure fit for the gasket 12 within the groove 24.

While one annular projection 28 is shown and described for the embodiments in FIGS. 2-9, it should be noted that more than one projection 28 may be utilized, if so desired. In addition, while one vertical member 30 is shown, more than one vertical member 30 may be utilized. Furthermore, while two horizontal members 34, 36 are shown, more or less than two horizontal members may be utilized, if so desired. It is preferred that the base portion 26 be sized to firmly seat within an annular groove 24 without rolling out of the groove 24 when force is applied to the annular projection 28, thereby avoiding inadvertent removal from the groove 24.

FIGS. 10-12 show the gasket 12 of the invention in operation between a bell 14 and spigot 16 of adjoining pipes 10. FIGS. 10 and 11 show the gasket 12 installed in an annular groove 24 defined in the first corrugation ridge 18 of the spigot 16. The smooth-walled bell 14 of an adjoining pipe 10 is installed over the spigot 16 so that the two pipes 10 are joined together in a pipe joint 22. The gasket 12 of FIGS. 2-5 is installed in the annular groove 24 in FIG. 10 and the gasket 12 of FIGS. 6-9 is installed in the annular groove 24 in FIG. 1. The gaskets 12 are installed such that the base portion 26 seats in the groove 24 and the annular projection 28 extends outwardly from the base portion 26. The annular projection 28 is bent over to close the gap between the bell 14 and spigot 16 of the adjoined pipes 10. In operation, the annular projection 28 is bent or crushed as the bell 14 is slid over the spigot 16. The projection 28 is designed to provide a soil tight seal according to AASHTO M294-02 (section 7.9.1) requirements.

FIG. 12 shows an alternative embodiment where the gasket 12 of FIGS. 6-9 is installed in the first valley 20 of the spigot 16 of a pipe 10. The gasket 12 has a size that is larger than if the gasket 12 were installed in the annular groove 24, but functionally performs in the same manner as a gasket 12 that is installed in an annular groove 24.

The gasket 12 of the invention is preferably sized and formed of a material that assists in preventing rolling of the gasket 12 during use. Rolling can cause the gasket 12 to roll out of the annular groove 24, such that an effective seal cannot be obtained. The gasket 12 preferably locks into the groove 24 and stands up in the groove 24 such that it will not roll out. In addition, by providing a projection 28 that has slightly smaller dimensions, and thus greater bendability, than the various legs 32 and members 30 of the base portion 26, the projection 28 bends rather than allowing the base portion 26 to be pushed or pulled from the groove 24.

In a preferred embodiment, the gasket 12 is formed of a polyolefin polymer, such as polyethylene or polypropylene. An advantageous property of many polyolefin polymers is that they do not stretch like prior art rubber gaskets. Polyolefins are also widely used and relatively inexpensive when compared to prior art elastomers. More preferably, the gasket 12 is formed of a blend of a high density polyethylene (HDPE) and a lower density polyethylene. The lower density polyethylene may be a low density polyethylene (LDPE), a linear low density polyethylene (LLDPE), or a medium density polyethylene (MDPE), or a combination of one or all of LDPE, LLDPE, and MDPE. Off specification products may also be utilized. One embodiment utilizes HDPE in the amount of about 80-95% and a lower density polyethylene in the amount of 5% to 20%. In yet another embodiment, about 90-92% of HDPE is utilized with 8-10% of a lower density polyethylene.

Other types of pliable and/or resilient materials may also be utilized with the gasket of the invention. For example, the material selected can be 100% polypropylene, 100% HDPE, 100% MDPE, 100% LDPE, 100% LLDPE, or blends of any or all of these materials. Elastomers, such as thermoplastics or thermosets, may alternatively be utilized with the unique structure or shape of the gasket and still maintain a substantial cost reduction. Thus, the present invention is not limited to the selection of a particular material.

The gasket 12 is preferably manufactured using an injection molding process, such that the gasket 12 is formed as a unitary annular structure. A one-piece gasket 12 holds its shape and is more stable when installing the gasket 12 into the gasket groove 24 than prior art extruded gaskets. After the gasket 12 is molded in an annular shape, the gasket 12 is installed in the annular groove 24 and the pipe 10 is shipped to customers. It is not necessary for customers to install the gasket 12 themselves since the pipes 10 preferably are provided with the gasket 12 already installed.

Advantageously, the gasket 12 of the invention has a minimal cost and provides assurances that the AASHTO soil tight requirements will be met. The cross-sectional shapes of the various embodiments of the gaskets 12 are made up of horizontal and vertical ribs, which minimize the use of material in the gasket 12. The gasket 12 of the invention is designed to be utilized in a wide range of sizes of pipes, such as 4 inches in diameter up to 30 inches in diameter. Larger pipes 10 may also utilize the gasket 12 according to the invention, such as pipes having a diameter of 36 inches to 60 inches, although it is currently difficult to injection mold gaskets of such large sizes for these pipes 10. For larger pipes, it may be necessary to extrusion mold the gasket 12 as a rope material and then cut it to size and weld the ends together, as known by those of skill in the art.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

1. A gasket for use with a pipe comprising:
an annular member having a plurality of legs coupled to at least one vertical member, with at least some of the plurality of legs being in the shape of a rib and the vertical member being in the shape of a rib, wherein at least one of the plurality of legs is at least one annular projection that extends at least partially radially outwardly from the annular member.

2. The gasket of claim 1, wherein the annular member is configured to seat in an annular groove defined in a pipe and the at least one annular projection is a finger-like rib that extends at least partially radially outwardly from the groove.

3. The gasket of claim 2, wherein at least one of the plurality of legs extends horizontally from one side of the at least one vertical member and at least one of the plurality of legs extends horizontally from the opposite side of the at least one vertical member, said horizontally extending legs being configured to engage the walls of the annular groove defined in the pipe.

4. The gasket of claim 3, wherein at least one of the plurality of legs extends vertically downwardly from the at least one vertical member.

5. The gasket of claim 3, wherein the at least one annular projection is a linear extension of the at least one vertical member and the linear extension is axially aligned with the vertical member.

6. The gasket of claim 5, wherein the at least one annular projection is a tapered rib.

7. The gasket of claim 1, wherein the at least one vertical member and at least some of the plurality of legs form an annular base portion and the at least one annular projection extends outwardly from the base portion, and each of the vertical member and legs are formed as ribs.

8. The gasket of claim 7, wherein the annular base portion has an I-shaped cross-section, and the annular base portion and the at least one annular projection are made of a pliable material.

9. The gasket of claim 8, wherein the at least one annular projection has a linear cross-sectional shape.

10. The gasket of claim 8, wherein the at least one annular projection is configured to bend when a sufficient level of force is applied to the projection.

11. The gasket of claim 8, wherein the annular I-shaped base portion is configured to seat in an annular groove of a pipe.

12. The gasket of claim 11, wherein the annular base portion includes at least two horizontal members and the at least one vertical member, with the horizontal members being configured to engage a wall of the annular groove of the pipe.

13. The gasket of claim 12, further comprising a base protrusion that extends radially inwardly from the at least one vertical member.

14. The gasket of claim 13, wherein the base protrusion is axially aligned with the at least one vertical member and is configured to engage the wall of the annular groove of the pipe; and the at least one annular projection is axially aligned with the at least one vertical member and is linear.

15. The gasket of claim 8, wherein the at least one annular projection has a profile that tapers from a point where the projection meets the I-shaped base portion to a tip and has a cross-sectional width that is equal to or less than the cross-sectional width of the at least one vertical member.

16. The gasket of claim 12, wherein the at least two horizontal members include an upper horizontal member and a lower horizontal member, with the upper horizontal member having a length that is greater than a length of the lower horizontal member.

17. The gasket of claim 11, wherein the at least one vertical member has a length that is less than a depth of the annular groove of the pipe that the gasket is configured to seat in.

18. The gasket of claim 8, wherein the base portion and the at least one annular projection are formed of the same pliable material and the pliable material consists essentially of a polyolefin polymer.

19. The gasket of claim 18, wherein the polyolefin polymer includes about 80-95% of a high density polyethylene and about 5-20% of a lower density polyethylene, with the lower density polyethylene comprising at least one of a linear low density polyethylene, a low density polyethylene, and a medium density polyethylene.

20. The gasket of claim 8, wherein the base portion and the at least one annular projection are formed of the same pliable material and the pliable material is an elastomer.

21. The gasket of claim 1, wherein the at least one linear extension is configured to bend upon the application of a sufficient force.

22. The gasket of claim 1, wherein the annular member has a cross-shaped cross-section with the at least one vertical member being coupled to the at least one annular projection to form an upright beam of the cross-shape, and at least some of the plurality of legs comprise at least one horizontal member extending outwardly from the sides of the vertical member and the annular projection in the vicinity of where the vertical member and annular projection are coupled, said at least one horizontal member forming a cross-beam of the cross-shaped cross section, wherein at least a portion of said annular member is configured to seat within an annular groove defined in a pipe, and at least a portion of said annular member is configured to extend from the annular groove of the pipe.

23. The gasket of claim 22, wherein the at least one annular projection is that portion of the annular member that extends from the annular groove of the pipe, and the at least one horizontal member and the at least one vertical member are that portion of the annular member that are configured to seat within the annular groove defined in a pipe.

24. The gasket of claim 22, wherein the at least one annular projection is axially aligned with the at least one vertical member.

25. The gasket of claim 22, wherein the at least one horizontal member includes an upper horizontal member and a lower horizontal member, with each horizontal member extending outwardly from the sides of the at least one vertical member, said upper and lower horizontal members being configured to engage a wall of the annular groove.

26. The gasket of claim 25, wherein the at least one vertical member extends from the upper horizontal member to below the lower horizontal member, such that a bottom end of the at least one vertical member is configured to engage the wall of the annular groove.

27. A gasket for use with a pipe comprising:
an annular member formed of a pliable material having a first portion sized for seating in an annular groove defined in a pipe and a second portion in the form of a finger-like rib extending outwardly from the first portion, whereby the second portion is for engaging an inner wall of an adjoining pipe, with the first and second portions being integrally formed as a single member, wherein the annular member consists essentially of a polyolefin polymer.

28. The gasket of claim 27, wherein the polyolefin polymer is at least one of polyethylene and polypropylene.

29. The gasket of claim 28, wherein the polyolefin polymer includes about 80-95% of a high density polyethylene and about 5-20% of a lower density polyethylene.

30. The gasket of claim 28, wherein the polyolefin polymer includes about 90-92% of a high density polyethylene and about 8-10% of a lower density polyethylene.

31. The gasket of claim 29, wherein the lower density polyethylene comprises at least one of a linear low density polyethylene, a low density polyethylene, and a medium density polyethylene.

32. The gasket of claim 27, wherein the second portion is configured to bend upon the application of a force equal to a force created when a pipe is adjoined with another pipe.

33. A pipe joint comprising:
a first pipe section;
a second pipe section operatively coupled to the first pipe section; and
the gasket of claim 1, said gasket sealingly engaging the first pipe section and the second pipe section in a manner to prevent the leakage of soil therebetween.

34. The pipe joint of claim 33, wherein the first pipe section has a spigot end, with an annular groove defined in the spigot end; and the second pipe section has a bell end configured to overlap the spigot end of the first pipe section; and the gasket is positioned in the annular groove of the first pipe section.

35. A pipe joint comprising:
a first pipe section;
a second pipe section operatively coupled to the first pipe section; and
the gasket of claim 27, the gasket sealingly engaging the first pipe section and the second pipe section in a manner to prevent the leakage of soil therebetween.

36. A corrugated pipe comprising:
an elongated tubular member having a bell end and a spigot end, with at least one annular groove being provided on one of the spigot end and the bell end; and
at least one annular gasket according to claim 1, wherein the annular gasket is configured to seat in the at least one annular groove, with the at least one annular projection extending outwardly from the groove.

37. The corrugated pipe of claim 36, wherein the at least one annular projection extends radially outwardly from the at least one vertical member.

38. The corrugated pipe of claim 36, wherein the elongated tubular member has a corrugation structure comprising a plurality of alternating ridges and valleys defined along at least a portion of the length thereof, and the annular groove is defined in one of the ridges.

39. The corrugated pipe of claim 36, wherein the corrugated pipe has a corrugation structure comprising a plurality of alternating ridges and valleys defined along at least a portion of the length thereof, and the annular groove is one of the valleys.

40. A corrugated pipe comprising:
an elongated tubular member having a bell end and a spigot end, with at least one annular groove being provided on one of the spigot end and the bell end; and
at least one annular gasket according to claim 27, wherein the annular gasket is configured to seat in the at least one annular groove, with at least part of the gasket extending outwardly from the groove.

41. A method of sealing a pipe joint comprising:
providing the gasket of claim 1;
providing an annular groove in a pipe that is sized to seat at least a portion of the annular member; and
installing the gasket in the annular groove of the pipe.

42. A method of sealing a pipe joint comprising:
providing the gasket of claim 27;
providing an annular groove in a pipe that is sized to seat at least a portion of the annular member; and
installing the gasket in the annular groove of the pipe.

43. A method of manufacturing a gasket for use with a pipe comprising:
providing a mold configured to form the gasket of claim 1 as a unitary member; and
injection molding a pliable material into the mold.

44. The method of claim 43, wherein the pliable material is a polyolefin polymer.
